(19) United States
(12) Patent Application Publication
(10) Pub. No.: US 2014/0326910 A1
(43) Pub. Date: Nov. 6, 2014

(54) RING GATE CONTROL SYSTEM AND CONTROL METHOD

(71) Applicant: Emerson Process Management Power and Water Solutions, Inc., Pittsburgh, PA (US)

(72) Inventors: Etkin Alexey Garrievich, Moscow (RU); Leschenko Oleg Dmitrievich, St. Petersburg (RU); Shavlovich Zoya Anatol'evna, St. Petersburg (RU)

(21) Appl. No.: 13/918,482

(22) Filed: Jun. 14, 2013

(30) Foreign Application Priority Data
May 6, 2013 (RU) 2013120514

(51) Int. Cl. F16K 31/04

(52) U.S. Cl. CPC F16K 31/04
USPC 251/129.11

(57) ABSTRACT

Ring gate control system and control method are disclosed herein. An example ring gate control system includes a first servomotor group, a second servomotor group, and a third servomotor group. Each servomotor group is associated with a respective control point located around an annular face of a ring gate. The servomotors within the groups coupled to the annular face of the ring gate at respective linkage points, a transmitter coupled to the annular face of the ring gate and a control valve coupled between a hydraulic source and the at least two actuators and a controller coupled to each of the control valves and to each of the transmitters. The controller is separately operating a closed control loop for each servomotor group to control positions of the control points to control a horizontal orientation of the ring gate.

### RELATED APPLICATIONS

This patent claims priority to Russian Patent Application No. 2013120514, filed May 6, 2013, which is hereby incorporated by reference herein in its entirety.

### FIELD OF THE DISCLOSURE

The present patent relates to hydropower machinery and, more particularly, to ring gate control systems of a hydroelectric turbine installation that allows or shuts off water flow through an electrical power generation turbine.

### BACKGROUND

Hydroelectric turbine installations used in electrical power generating plants utilize ring gates to effect shut off of a water flow path from an upstream reservoir, such as a river or a lake, through an electrical power generation turbine to a downstream depository. Ring gates (which are also referred to as cylindrical gates) are used in hydroelectric turbines as penstock shut off devices instead of conventional butterfly valves or spherical valves. A ring gate includes a gate ring which is a thin, short solid cylinder that surrounds a turbine runner which, when placed in the closed position, blocks the water flow passage between a distributor and a stay ring of a hydroelectric generator. The gate ring, which serves as an isolating valve, is typically disposed in the distributor of the turbine between the stay vanes and the wicket gates. When the ring gate is in the open position, the gate ring is typically housed in a compartment formed between a stay ring and a head cover, where the gate ring remains completely retracted from the water flow passage. During normal operation, the ring gate is closed after the wicket gates are closed and, at unit start-up, the ring gate is opened before the wicket gates start to open. For emergency conditions and/or situations, the gate ring may be used to close against full flow.

### BRIEF DESCRIPTION OF THE DRAWINGS

FIG. 1 illustrates a cross sectional view of a hydro-electric power plant turbine system using a ring gate to shut off the flow of water to a Francis turbine.

FIG. 2A illustrates a perspective view of an example ring gate and servomotor system having three servomotor groups, each having two servomotors, that can be used to control movement of the ring gate of FIG. 1.

FIG. 2B illustrates a top view of an example ring gate and servomotor system having three servomotor groups, each having two servomotors, that can be used to control movement of the ring gate of FIG. 1.

FIG. 3A illustrates a perspective view of an example ring gate and servomotor system having three servomotor groups, each having three servomotors, that can be used to control movement of the ring gate of FIG. 1.

FIG. 3B illustrates a top view of an example ring gate and servomotor system having three servomotor groups, each having three servomotors, that can be used to control movement of the ring gate of FIG. 1.

FIG. 4 illustrates an example combined schematic diagram of a control system that can be used to control the example ring gate of FIGS. 2 and 3.

FIG. 5 illustrates a structural diagram of an example control system that can be used to control the example ring gate of FIGS. 2 and 3.

### DETAILED DESCRIPTION

To assure proper functioning of a gate ring during operation, a control system that controls movement of the gate ring keeps the gate ring in a horizontal state with specific accuracy when the gate ring is traveling between the open and closed positions. The horizontal orientation prevents wedging of the gate ring during movement. Also, to assure proper functioning of a gate ring during operation, the control system that controls movement of the gate ring limits deformation of the gate ring, which also avoids wedging, while imparting a significant amount of force on the gate ring to move the gate ring. As a result of these constraints and to assure proper two dimensional gate ring orientation of the gate ring during movement, ring gate drive systems use more than three servomotors to move the gate ring.

Examples of known ring gate control systems that use mechanical links are described in U.S. Pat. No. 4,434,964 and PCT Patent Publication WO 99/43954. As described, a ring gate is operated by a set of servomotors positioned at spaced apart locations around the circumference of a gate ring. These servomotors are synchronized by mechanically coupling pairs of adjacent servomotors using chain loops such that each set of two adjacent servomotors are connected by a continuous chain loop. In one configuration, a total of six chain loops is required for a six servomotor arrangement. Moreover, each chain loop must include its own chain tensioner to maintain proper tension in each of the individual chains. To keep the gate ring in a horizontal orientation, accurate and rigid screw pairs and drives are required.

Each of these ring gate control systems includes many mechanical parts that are subject to wear and tear (e.g., the chain loops and sprockets for the chains), are relatively complicated and expensive to build and maintain and require laborious adjustment, tuning (e.g., using chain loop tensioners) and maintenance. In addition, when mechanical links are applied to more than three servomotors, the control system becomes statically indeterminate, and the effective hauling ability decreases because the servomotors load each other mutually due to parameters spread in their control channels. As a result, the ability to take external loading by the gate ring is decreased.

PCT Patent Publication WO 99/43954 describes a control system that uses both hydro-mechanical and electro-hydraulic links to keep a gate ring in a horizontal orientation. The system includes a considerable number of hydraulic valves as well as volume batchers. The system also includes a number of motors and/or pumps equal to the number of servomotors. The configuration of hydraulic valves, motors, pumps, etc., makes the system complicated and more expensive because of the amount of hydraulic equipment and the labor associated with tuning the system. In addition, for more than three servomotors, the control system becomes statically indeterminate, which decreases the effective hauling ability of the system. When the control system is statically indeterminate, the controller tuning algorithm is also indeterminate, which increases the amount of labor associated with tuning the control system.

An example ring gate control system disclosed herein uses three identical and separate position control closed loops that control vertical coordinates of three control points with high precision. These control points are spaced apart equally about the circumference of the gate ring. The vertical coordinates of the control points define a horizontal orientation of the gate ring uniquely. Position control closed loops receive the same input signals and operate together to move the ring gate between an open position and a closed position. Because of the high precision of the position control closed loops, displacements of the control points during movement differ from each other insignificantly and the gate ring maintains horizontal orientation within predetermined limits.

In some examples, each position control closed loop includes a separate group of servomotors (e.g., hydraulic cylinders). Each servomotor group includes two or more individual servomotors coupled to drive the gate ring. Each group of servomotors is associated with moving one of the three control points. Each position control closed loop also includes a separate feedback position/velocity transmitter coupled to its respective control points. A control valve controls the operation of the servomotors within the servomotor group. In some examples, the servomotors within the servomotor group are hydraulically connected to each to other in parallel. In some examples, an electric controller controls the operation of the control valve and closes the position control loop via feedback from the position/velocity transmitter.

The disclosed example ring gate control system is simpler in design than prior art ring gate control systems, because the ring gate control system does not require mechanical linkages disposed between each of the servomotors and does not require a separate control valve for each servomotor. As such, the example control system has less components, is easier to assemble and has increased reliability. Also, the example control system, which uses three independent position closed control loops, is statically determinate, because the control loops control the positions of the three control points on the gate ring. Being statically determinate enables easy and clear closed control loop tuning procedures, which enables a higher degree of reliability. The ring gate control system described herein has fewer components, becomes statically determinate, which enables easy and clear tuning of the closed control loops and uses only three independent control channels, which may be easily tuned. The foregoing features provide for more reliability during the operation of the ring gate control system.

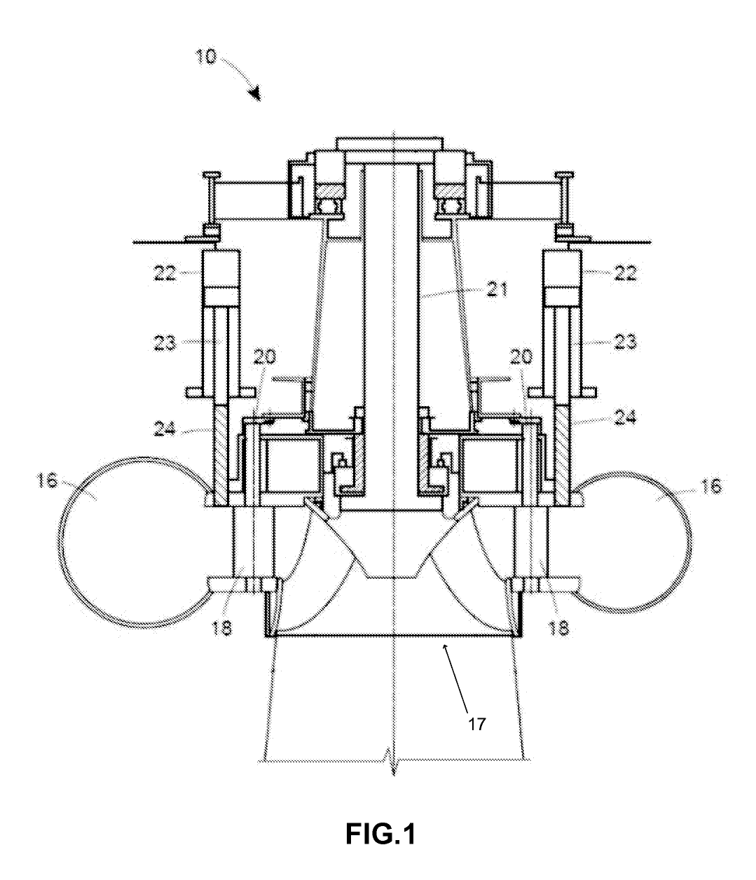

FIG. 1 illustrates a cross sectional view of an example turbine system 10 that is used in a hydro-electric power generation plant. The turbine system 10 is used to generate electricity from water flowing from an upstream reservoir, such as a river or a lake, through a penstock pipe and the turbine system 10 to a downstream depository, such as a river (not shown). A spiral casing 16 is connected to an upstream penstock pipe that provides water for driving the turbine 21. As illustrated in FIG. 1, guide vanes 18 of a wicket gate 20 are disposed between the spiral casing 16 and a turbine housing 17 to direct water flow to a turbine runner from all sides of the housing 17 during operation of the turbine 21. A gate ring 24 is a relatively thin, short solid cylinder that surrounds a turbine. In the closed position, the gate ring 24 blocks the water flow. In the open position, the gate ring 24 is retracted from the water flow passage.

The example turbine system 10 includes a ring gate system having multiple servomotors 22 mechanically coupled to the gate ring 24 via piston rods 23. While only two servomotors 22 are illustrated in FIG. 1, the ring gate system can include six or more servomotors. Each servomotor 22 is a hydraulic cylinder that drives movement of the piston rod 23 connected to the gate ring 24. The gate ring 24 is illustrated in FIG. 1 in a fully retracted (fully open) position so that the gate ring 24 is completely out of the fluid flow path from the spiral casing 16 to the turbine housing 17. The servomotors 22 operate together to force the gate ring 24 down into the flow path to shut off and/or control the flow of water between the spiral casing 16 and the turbine hosing 17 when the gate ring 24 is in the fully closed (un-retracted) position. More particularly, when the gate ring 24 is in the closed position, the gate ring 24 is completely disposed in the path between the staving of the spiral casing 16 and the guide vanes 18 of the wicket gate 20. The ring gate control system moves the gate ring 24 in a vertical direction to open or to fully shut off water flow to the turbine guide vanes 18.

To maintain the state of the gate ring 24 in a horizontal orientation within a certain or predetermined level of accuracy during movement of the gate ring 24 between the open and the closed positions, in some examples, the example ring gate control system described herein controls the operation or movement of the gate ring 24 by separately controlling three identical groups of servomotors connected to the gate ring 24. Each servomotor group may include two or more individual servomotors coupled to linkage points at the circumference on the gate ring 24. Because each group of servomotors 22A, 22B, 22C includes more than one servomotor, the ring gate control system 40 can use an adequate number of servomotors to provide the power or force necessary to move the gate ring 24 oriented in a horizontal orientation to a desired degree of accuracy. The number of servomotors within servomotor group may be any desired number such as two, three, four, etc. However, in the examples described herein, the number of servomotors within each of the different groups is the same. It is preferable that within a servomotor group the servomotors are the same type and/or size. The sizes of the servomotors may be different, but within each of the different groups there are to be pairs of the same size servomotors. Also, the servomotors of the pair are to be disposed symmetrically about a plane crossing the respective control point and being coincident with a gate ring axis. In an example using an odd number of servomotors within a servomotor group, a single servomotor have no pair. In some examples, the servomotor groups are identical.

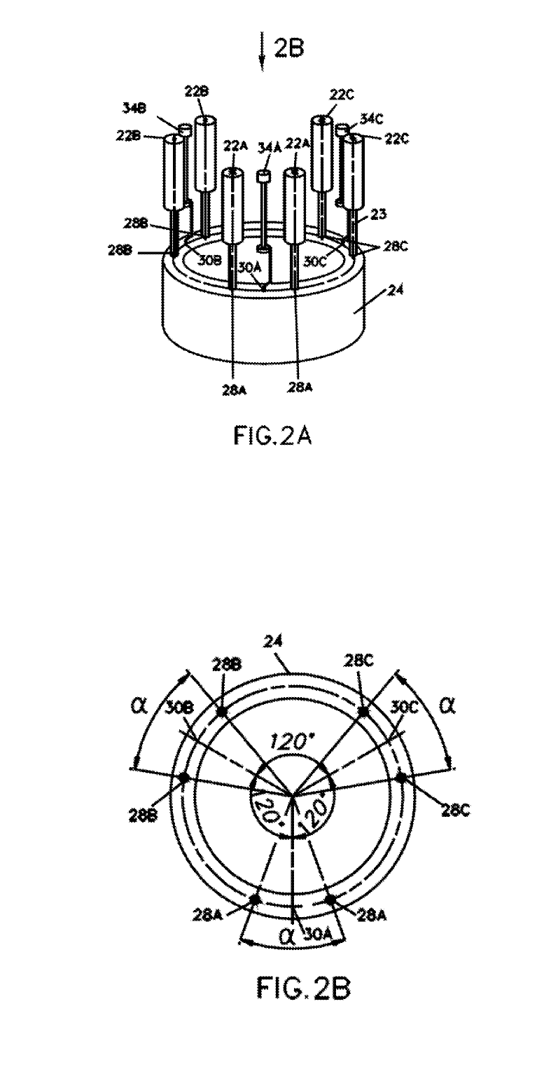

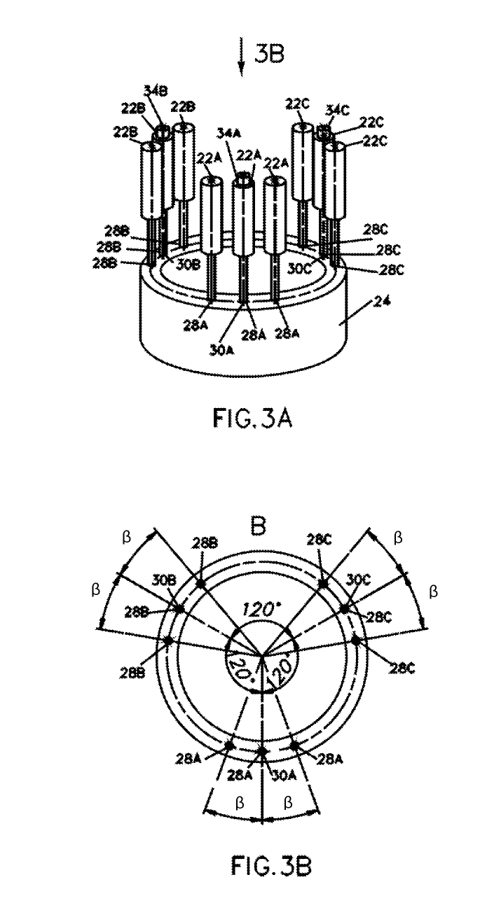

FIGS. 2A, 2B, 3A and 3B illustrate two examples in which servomotor groups, feedback position/velocity transmitters, control points and linkage points are configured to control the gate ring 24 of FIG. 1. FIGS. 2A and 2B illustrates an example in which the number of servomotors in the groups is even. FIGS. 3A and 3B illustrate an example in which the number of servomotor in the groups is odd. Three control points 30A, 30B, 30C are defined and spaced apart equally at the circumference on the gate ring 24. Linkage points 28A, 28B and 28C of servomotor groups are symmetrically disposed about one of the three planes crossing the respective control points 30A, 30B and 30C of the servomotor group and coinciding with an axis of the gate ring 24 Servomotors 22A, 22B and 22C are coupled to gate ring at the respective linkage points 28A, 28B, 28C via the piston rods 23. Three feedback position/velocity transmitters 34A, 34B, 34C are coupled to the gate ring 24 at the respective control points 30A, 30B, 30C.

In the example of FIG. 2B, the lines associated with the control points 30A, 30B, and 30C are separated by 120° so that the control points 30A, 30B, and 30C are equally separated from each other along the annular face of the ring gate 24. FIG. 2B shows the servomotors in each servomotor group positioned along the annular face of the ring gate 24 based on an angle α. For example, the linkage points 28A associated with the servomotors 22A are separated by angle α and positioned so each linkage point 28A is equidistant from the control point 30A. The even distribution of the servomotors 22A around the control point 30A balances forces used to drive the ring gate 24. In this example, the angle α is about 60°. In other examples, the angle α is to be equal to or less than 60°. Further, in examples where additional servomotors are implemented, the servomotors are positioned to evenly distribute force on the ring gate 24 in relation to the control points 30A, 30B, and 30C.

In the case of an even number of servomotors in the servomotor groups, the position/velocity transmitters 34A, 34B and 34C are coupled to control points via brackets, as shown at FIG. 2A.

As shown at FIG. 3A, in the case of an odd number of servomotors in servomotor groups, the position/velocity transmitters 34A, 34B and 34C are incorporated in the servomotors, which are coupled to respective control points 30A, 30B and 30C via the piston rods 23. FIG. 3B shows a plan view of the ring gate 24 of FIG. 3A. The illustrated example also shows the positioning between the respective linkage points 28A, 28B, and 28C of the servomotors 22A, 22B, and 22C. In this example, each of the linkage points within an servomotor group is separated by an angle β. In some examples, the angle β is about 30° or less than 30°. In this example, the angle β is based on a line that crosses the respective control points 30A, 30B, and 30C and intersects at a central or longitudinal axis of the ring gate 24.

Position/velocity transmitters used in the control system described herein are of contactless type. The position/velocity transmitters measure the position and/or velocity of the gate ring 24 based on measurement displacement via effect of interaction between permanent magnet and waveguide. Such transmitters generate position and velocity outputs.

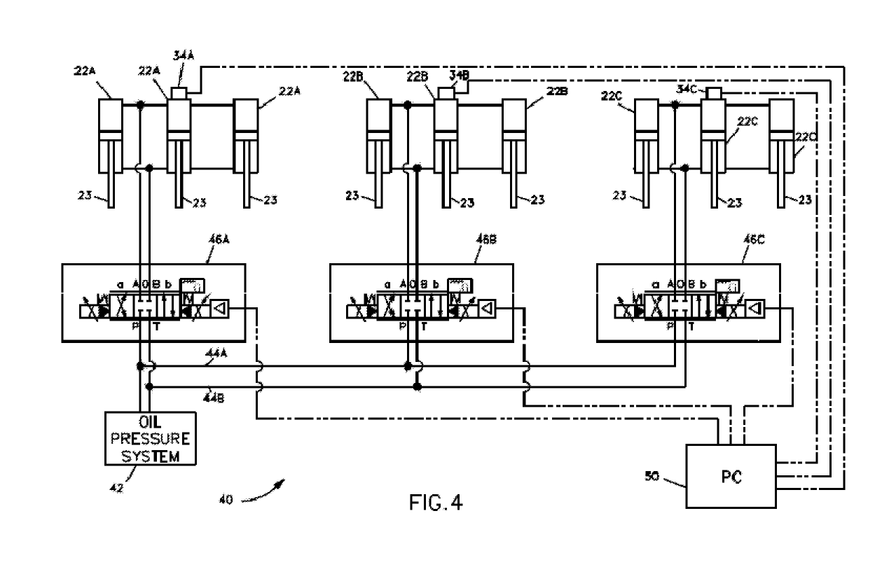

FIG. 4 illustrates a combined schematic diagram of the control system described herein for the example of FIG. 3. The servomotors in each group are connected hydraulically to each other in parallel and together to respective proportional valves. Three proportional valves 46A, 46B, 46C are separately coupled to a programmable controller 50. Position/velocity transmitters 34A, 34B, 34C also are separately coupled to the programmable controller 50. The position/velocity transmitters 34A, 34B, 34C are built into the servomotor and are separably coupled to the control points. All proportional valves are supplied with pressurized oil through oil line 44A and return line 44B via oil pressure system 42.

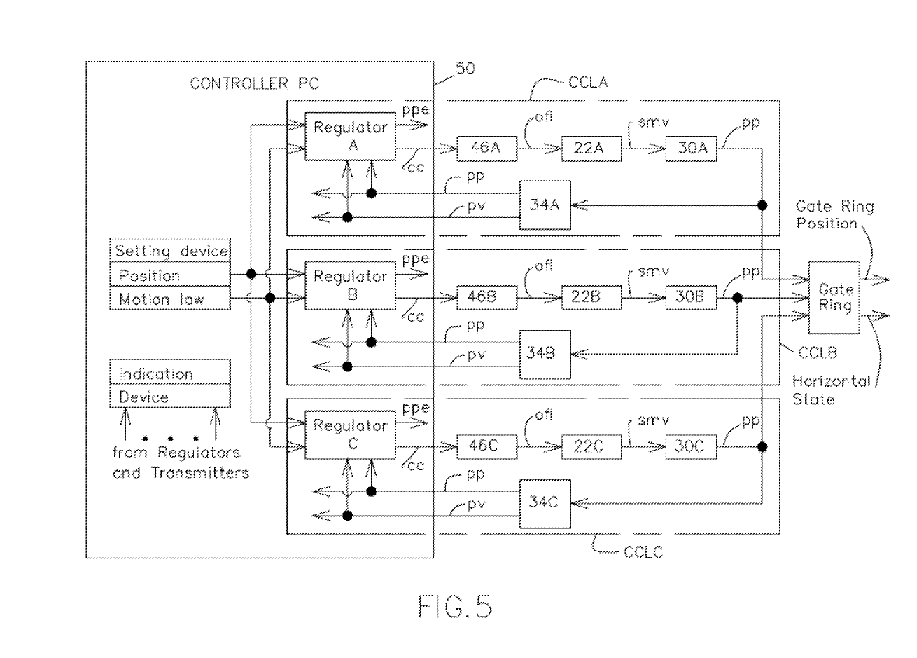

FIG. 5 illustrates a structural diagram of the control system that controls the ring gate of FIGS. 2 and 3. FIG. 5 discloses the links between the functional parts of the ring gate system.

The ring gate control system described herein is made up of three independent position closed control loops CCLA, CCLB, CCLC. These position closed control loops are identical. Output signals from controller 50 control the servovalves (proportional valves) 46A, 46B, 46C to supply the appropriate oil flow to groups of respective servomotors 22A, 22B and 22C that provoke servomotor groups movement with velocity <<smv>> and changing positions (vertical coordinates) <<pp>> of the respective control points 30A, 30B and 30C. Feedback position/velocity transmitters 34A, 34B, 34C generate current position (vertical coordinates) outputs <<pp>> and velocity outputs <<pv>> of the respective control points 30A, 30B and 30C. Electrical regulators A, B, C, via position outputs of position/velocity transmitters, implement three position based closed control loops CCLA, CCLB, CCLC. Velocity outputs of the transmitters may be used for reducing position errors of the position closed control loops by implementing inner feedbacks of the closed control loops.

As the three control points 30A, 30B, 30C are spaced equally around the gate ring 24, the closed control loops define and control the vertical coordinates of the three control points and, thus, define the position and the horizontal state of the gate ring 24. When controlling the coordinates of the three control points 30A, 30B, 30C, as described above, the closed control loops are independent of one another because the ring gate control system 40 is statically defined and any minor vertical displacements of one control point does not cause vertical displacements of other control points. Thus, the ring gate control system 40 is made up of three independent position based closed control loops, each of which is easy to operate and tune with high accuracy. The closed control loops receive equal input signals so that deviation of the gate ring horizontal orientation is defined by differences of the control points vertical displacement. Additionally or alternatively, deviation of the gate ring horizontal orientation is defined by differences of position errors of the position based closed control loops CCLA, CCLB, CCLC. Consequently, synchronization of travel of the three control points 30A, 30B, 30C defining the horizontal state of the gate ring 24 is provided by the high accuracy of the three independent position control loops, which are also able to correct the relative or absolute vertical coordinates of the control points during operation of the ring gate 24.

What is claimed is:

1. A ring gate control system for controlling movement of a ring gate between an open position and a closed position, comprising:
three servomotor groups, each servomotor group associated with one of three control points disposed around a circumference of a gate ring, each servomotor group including:
servomotors hydraulically connected in parallel to one another and coupled to the gate ring at linkage points on the gate ring, the linkage points being disposed about the circumference of the gate ring symmetrically about a plane, crossing the respective control points and coinciding with an axis of the gate ring;
a transmitter coupled to detect a position of the respective control point of the servomotor group;
a control valve coupled between a hydraulic source and the servomotors within the servomotor group for controlling a flow of pressurized fluid to the servomotors within the servomotor group; and
a controller coupled to each of the control valves and to each of the transmitters, the controller to implement three separate position closed control loops to control positions of the control points, the position closed control loops being operable to simultaneously control the positions of the control points on the gate ring to keep the gate ring oriented in a horizontal orientation within a predetermined range of accuracy.

2. The ring gate control system of claim 1, wherein the control points are disposed 120 degrees apart from one another around the circumference of the gate ring.

3. The ring gate control system of claim 2, wherein each servomotor group includes two servomotors.

4. The ring gate control system of claim 3, wherein the two servomotors of each servomotor group are coupled to the gate ring at linkage points that are disposed at sixty degrees or less than sixty degrees apart from one another around the circumference of the gate ring and at equidistant locations on either side of the respective control point.

5. The ring gate control system of claim 1, wherein each servomotor group includes three servomotors.

6. The ring gate control system of claim 5, wherein a first servomotor and a second servomotor of each servomotor group are coupled to the gate ring element at linkage points that are disposed at sixty degrees or less than sixty degrees apart from one another around the circumference of the gate ring and at equidistant locations on either side of the respective control point and wherein a third servomotor of each servomotor group is coupled to the gate ring at a linkage point that is coincident with the respective control point.

7. The ring gate control system of claim 1, wherein each servomotor group includes an even number of servomotors, including one or more pairs of servomotors, the servomotors in each pair of servomotors being coupled to the gate ring at circumference on the gate ring that are equidistant apart from the respective control point on either side of the respective control point.

8. The ring gate control system of claim 7, wherein each servomotor group includes one or more pairs of servomotors, and wherein each adjacent set of servomotors within each servomotor group is coupled to the gate ring at linkage points that are spaced apart equally.

9. The ring gate control system of claim 1, wherein each servomotor group includes an odd number of servomotors, including one or more pairs of servomotors, the servomotors in each pair of servomotors being coupled to the gate ring at linkage points on the circumference of the gate ring that are equidistant apart from a respective control point on either side of the respective control point and including a single servomotor coupled to the gate ring at a linkage point that is coincident with the respective control point.

10. The ring gate control system of claim 1, wherein the transmitters measure a movement of a piston rod coupled to a respective control point.

11. The ring gate control system of claim 1, wherein the controller simultaneously controls a vertical positions of three control points on the gate ring to keep the gate ring oriented in the horizontal orientation within the predetermined range of accuracy during movement of the gate ring.

12. The ring gate control system of claim 1, wherein the servomotors are linear servomotors.

13. A method of controlling an operation of a ring gate having a plurality of servomotors coupled to the gate ring at linkage points disposed around the circumference of the gate ring, comprising:
measuring movement or a position of each of three control points to form three feedback signals; and
simultaneously using the input control signals to control vertical positions of the control points to control movement and horizontal orientation of the gate ring.

14. The method of claim 13, wherein using the control signals to control the vertical positions of the control points includes providing each of the control signals to a different control valve, each control valve being disposed between a pressurized fluid source and a different one of the servomotor groups to enable the same control valve to control the oil flow provided to all of the servomotors in one of the servomotor groups.

15. The method of claim 13, wherein measuring the movement or the position of each of the three control points includes measuring movement or a position of piston rods or brackets coupled to each of the three control points.

16. A ring gate control system, comprising:
a first servomotor group, a second servomotor group, and a third servomotor group, each servomotor group associated with a respective control point located around an annular face of a ring gate, each actuator group being associated with:
servomotors of the servomotor groups coupled to the annular face of the ring gate at respective linkage points;
a transmitter coupled to the annular face of the ring gate; and
a control valve coupled between a hydraulic source and the at least two actuators; and
a controller coupled to each of the control valves and to each of the transmitters, the controller separately operating a closed control loop for each servomotor group to control positions of the control points to control a horizontal orientation of the ring gate.

17. The ring gate control system of claim 16, wherein the respective control points for the servomotor groups are equally spaced around the annular face of the ring gate.

18. The ring gate control system of claim 16, wherein each of the transmitters is to detect a position of the respective control point of the servomotor group associated with the feedback position transmitter.

19. The ring gate control system of claim 16, wherein the control valve is to control a flow of pressurized fluid to the servomotors within the servomotor group.

20. The ring gate control system of claim 16, wherein the linkage points of each servomotor group are located less than sixty degrees apart from each other on the annular face of the ring gate.
